(19) United States
(12) Patent Application Publication
(10) Pub. No.: US 2026/0005594 A1
(43) Pub. Date: Jan. 1, 2026

(54) POWER CONVERTER WITH VOLTAGE SUPPORT CIRCUIT

(71) Applicant: TEXAS INSTRUMENTS INCORPORATED, Dallas, TX (US)

(72) Inventor: Daniel Mavencamp, Rockwall, TX (US)

(21) Appl. No.: 18/759,825

(22) Filed: Jun. 29, 2024

(51) Int. Cl. H02M 1/00

(52) U.S. Cl. CPC H02M 1/0093; H02M 1/0019

(57) ABSTRACT

An apparatus includes a power converter having a first voltage terminal and a second voltage terminal and including a voltage divider coupled between the second voltage terminal and a voltage supply terminal. The voltage divider has an output. A transconductance amplifier has a first input, a second input, and an output. The first input is coupled to the output of the voltage divider. The second input is coupled to a reference voltage circuit. A first capacitor is coupled between the output of the transconductance amplifier and the voltage supply terminal. A buffer has an input coupled to the output of the transconductance amplifier and has an output. A second capacitor is coupled between the output of the buffer and the second voltage terminal.

### BACKGROUND

A power converter converts an input voltage into an output voltage. The speed at which a power converter responds to a sudden change in load current is referred to as the transient response of the power converter. For at least some power converters, a sudden increase in load current may cause the power converter's output voltage to temporarily drop (output voltage droop) before the power converter is able to cause the output voltage to recover back to its nominal level. For some devices containing a power converter, the magnitude and time duration of the voltage droop may be problematic for the operation of the device. The Universal Serial Bus Power Delivery (USB PD) specification has specific requirements for a device's output transient response.

### SUMMARY

In an example, an apparatus includes a power converter having a first voltage terminal and a second voltage terminal and including a voltage divider coupled between the second voltage terminal and a voltage supply terminal. The voltage divider has an output. A transconductance amplifier has a first input, a second input, and an output. The first input is coupled to the output of the voltage divider. The second input is coupled to a reference voltage circuit. A first capacitor is coupled between the output of the transconductance amplifier and the voltage supply terminal. A buffer has an input coupled to the output of the transconductance amplifier and has an output. A second capacitor is coupled between the output of the buffer and the second voltage terminal.

In another example, an apparatus includes a power converter having a first voltage terminal and a second voltage terminal. The apparatus also includes an amplifier having a first input, a second input, and an output. The first input and the output are coupled to the second voltage terminal.

In yet another example, an apparatus includes a power converter and a voltage support circuit. The power converter has a first voltage terminal and a second voltage terminal. The voltage support circuit has an input and an output. The input and the output are coupled to the second voltage terminal. The voltage support circuit is configured to respond to a reduction in an output voltage at the second voltage terminal by increasing the output voltage based on a reference voltage and the output voltage.

### BRIEF DESCRIPTION OF THE DRAWINGS

FIG. 1 is a schematic diagram of a power converter coupled to a voltage support circuit, in an example.

FIG. 2 is a schematic diagram of the voltage support circuit of FIG. 1, in an example.

FIG. 3 are waveforms illustrating the benefit of the voltage support circuit in reducing the amount of output voltage dip during a load transient relative to a power converter that does not include the voltage support circuit, in an example.

FIG. 4 is a schematic diagram of a bidirectional power converter coupled to the voltage support circuit in an example.

FIG. 5 is a schematic diagram of the bidirectional power converter and voltage support circuit of FIG. 4 showing additional detail of the bidirectional power converter, in an example.

FIG. 6 is a system diagram illustrating two devices coupled by a Universal Serial Bus (USB) in which at least one of the devices includes a power converter and voltage support circuit, in an example.

### DETAILED DESCRIPTION

The same reference numbers or other reference designators are used in the drawings to designate the same or similar (either by function and/or structure) features.

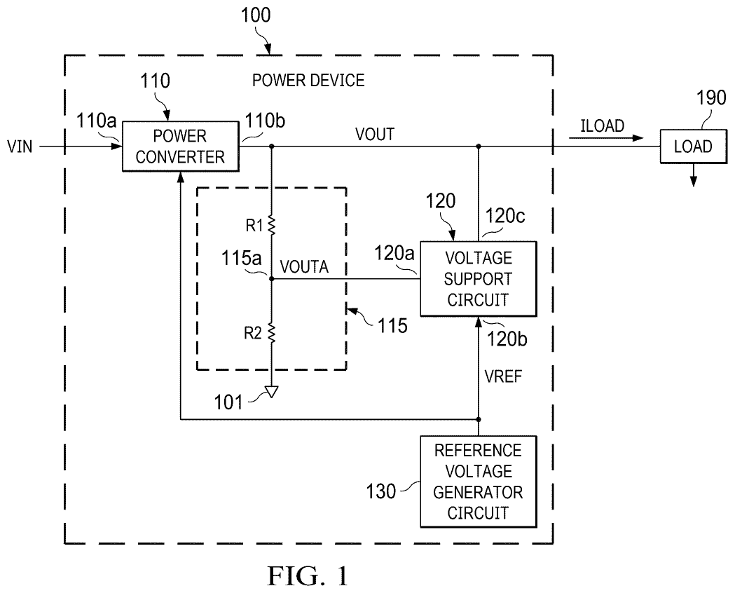

FIG. 1 is a block diagram of a power device 100 including a power converter 110, a voltage divider 115, a voltage support circuit 120, and a reference voltage generator circuit 130. Power device 100 may be fabricated as an integrated circuit (IC) including power converter 110, voltage divider 115, voltage support circuit 120, and reference voltage generator circuit 130. Power converter 110 has an input 110a and an output 110b. An input voltage VIN is provided to input 110a. Power converter 110 generates a load current ILOAD, which is provided to a load 190 thereby generating an output voltage VOUT at output 110b. Power converter 110 may be any suitable type of switching power converter including, for example, buck converter or a boost converter.

Power converter 110 regulates the output voltage VOUT to a target level. Any sudden change in load current ILOAD (e.g., faster than the bandwidth of the power converter) may cause a change in the magnitude of the output voltage VOUT before a control loop within power converter 110 can respond to re-establish regulation of VOUT. Power converter 110 has a transient response (also referred to as a bandwidth) which characterizes how fast power converter 110 can respond to sudden changes in the magnitude of the load current ILOAD. Upon a sudden increase in load current ILOAD (such as that shown in FIG. 3, for example), a power converter with a slower transient response results in a larger drop of the magnitude of the output voltage VOUT before re-establishing regulation of VOUT at its target level compared to a power converter with a faster transient response. Some applications that use a power converter cannot tolerate large output voltage drops upon a sudden increase in load current ILOAD as well as other applications. For example, many systems have dynamic and variable loads. For example, a system including a microprocessor may experience large fluctuations in its quiescent current. By way of another example, a system including a display can add a significant dynamic load to a power converter. Further still, a mobile phone transmitter may present a strong dynamic load to a power converter as the transmitter frequently transitions between a sleep state and a fully operational state to communicate with a cellular base station.

Voltage support circuit 120 helps to reduce the magnitude of a drop of the output voltage VOUT upon a sudden increase in load current ILOAD. In one example, voltage support circuit 120 is beneficial to use in combination a power converter 110 that has a transient response that is too slow for a given application. Voltage support circuit 120 has input 120a and 120b and an output 120c. In the example of FIG. 1, voltage divider 115 includes resistors R1 and R2 coupled in series between output 110b of power converter 110 and a voltage supply terminal 101 (e.g., ground). The connection between resistors R1 and R2 is the output 115a of voltage divider 115 and provides a scaled-down version of output voltage VOUT. The output voltage at output 115a of voltage divider 115 is voltage VOUTA. Output 115a of voltage divider 115 is coupled to input 120a of voltage support circuit 120. A reference voltage VREF, used to control the power converter's output voltage, is provided to input 120b of voltage support circuit 120. In the example of FIG. 1, reference voltage VREF is generated by a reference voltage generator circuit 130. In other examples, reference voltage VREF is generated externally to power device 100 and provided to the power device.

Voltage support circuit 120 responds to a reduction in output voltage VOUT relative to reference voltage VREF by causing output voltage VOUT to increase. Advantageously, voltage support circuit 120 is able to prevent output voltage VOUT from dropping as much as VOUT otherwise would drop absent the voltage support circuit 120 during a sudden increase in load current ILOAD that exceeds the bandwidth of power converter 110.

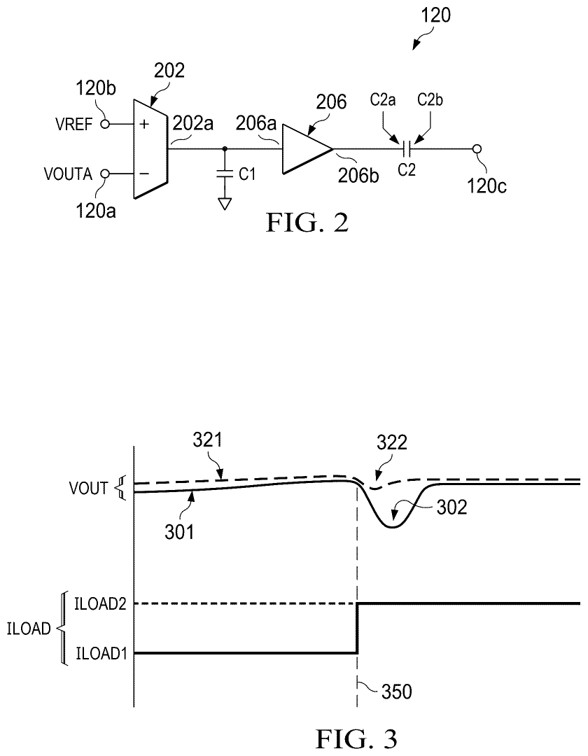

FIG. 2 is a schematic diagram of voltage support circuit 120 including a transconductance amplifier 202, capacitors C1 and C2, and a buffer 206. Transconductance amplifier 202 has a positive (+) input, a negative input (−), and an output 202a. Buffer 206 has an input 206a and an output 206b. The positive input of transconductance amplifier 202 is coupled to input 120b of voltage support circuit 120 and receives voltage VREF, and the negative input of transconductance amplifier 202 is coupled to input 120a and receives voltage VOUTA. The output 202a of transconductance amplifier 202 is coupled to the input 206a of buffer 206. One terminal of capacitor C1 is coupled to the output 202a of amplifier 202, and the other terminal of capacitor C1 is coupled to the voltage supply terminal (ground) 101. Terminal C2a of capacitor C2 is coupled to the output 206b of buffer 206, and terminal C2b of capacitor C2 is coupled to the output 120c of voltage support circuit 120.

Transconductance amplifier 202 amplifies the difference between VREF and VOUTA and produces an output current that charges capacitor C1 to a voltage proportional VREF-VOUT. The output current from transconductance amplifier 202 is converted to a voltage by charging capacitor C1. Accordingly, the voltage across capacitor C1 is proportional to VREF-VOUT. Buffer 206 has a relatively high input impedance to avoid loading the output of transconductance amplifier 202. The output voltage from buffer 206 at output 206b is also proportional to VREF-VOUT. If VOUT were to drop relative to VREF due to, for example, a load transient on power converter 110 that exceeds its transient response, the voltage on terminal C2a of capacitor C2 will increase thereby causing a commensurate increase in the voltage on terminal C2b of capacitor C2. Terminal C2b of capacitor C2 is coupled to the output 120c of voltage support circuit 120 which is coupled to the output 110b of power converter 110. The response of voltage support circuit 120 is faster than the transient response of power converter 110. Accordingly, upon a sudden increase in load current ILOAD, voltage support circuit 120 prevents output voltage VOUT from dropping as much as it would otherwise absent voltage support circuit 120 until power converter 110 can again achieve regulation of the level of VOUT.

FIG. 3 are graphs 301 and 321 of the output voltage VOUT in an example. Graph 301 is an example of output voltage VOUT for power device 100 that does not have voltage support circuit 120. Graph 321 is an example of output voltage VOUT for power device 100 that includes voltage support circuit 120. FIG. 3 also shows a graph of load current ILOAD in an example. At time point 350, the load current ILOAD experiences a sudden increase as it transitions from lower current level ILOAD1 to higher current level ILOAD2. The sudden jump in load current is fast enough to exceed the transient response of power converter 110. Without voltage support circuit 120, output voltage VOUT for graph 301 as a significant drop 302. With voltage support circuit 120, output voltage VOUT for graph 321 advantageously has a much smaller drop 322.

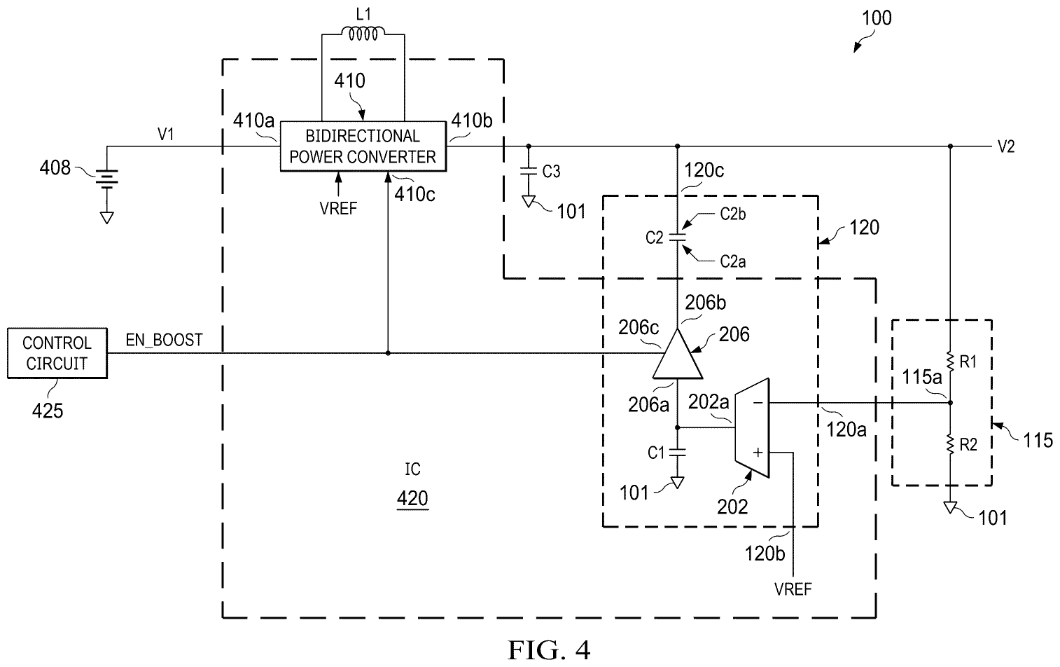

FIG. 4 is a schematic diagram of a power device 100 including a bidirectional power converter 410 having terminals 410a and 410b and an enable input 410c. Power device 100 in the example of FIG. 4 also includes a capacitor C3, voltage divider 115, and voltage support circuit 120. Bidirectional power converter 410 is coupled to or includes an inductor L1. Capacitor C3 is coupled between terminal 410b and the voltage supply terminal 101. Voltage divider 115 and voltage support circuit 120 are configured as described above.

An input voltage can be provided at either terminal 410a or 410b and the bidirectional power converter 410 produces an output voltage at the other of the terminals 410a, 410b. FIG. 4 shows a voltage V1 at terminal 410a and a voltage V2 at terminal 410b. In one direction (left to right in FIG. 4), bidirectional power converter receives voltage V1, e.g., from a battery 408, as an input voltage and generates voltage V2 as an output voltage. In the other direction, (right to left), bidirectional power converter receives voltage V2 as an input voltage and generates voltage V1 as an output voltage. In one direction, bidirectional power converter 410 operates as boost converter, and in the other direction, bidirectional power converter 410 operates as a buck converter. For example, from left to right, bidirectional power converter 410 operates as a boost converter, and from right to left, bidirectional power converter 410 operates as a buck converter. Power device 100 in FIG. 4 includes a control circuit 425 that provides an enable boost (EN_BOOST) signal to enable bidirectional power converter 410 to operate as a boost converter to thereby boost voltage V1 to a higher voltage V2. Based on the logic state, the enable boost signal EN_BOOST configures the bidirectional power converter to operate as boost converter (e.g., EN_BOOST is logic high) or a buck converter (e.g., EN_BOOST is logic low).

Inductor L1 may be the input inductor when bidirectional power converter 410 is operating as a boost converter. Inductor L1 may be the output inductor when bidirectional power converter 410 is operating as a boost converter. When operating as a buck converter, the ripple current from the buck converter is inversely proportional to the inductance of inductor L1. For example, Iripple=R*1−D/fₛ*L, where D is the duty cycle, fₛ is the switching frequency, and R is the resistance of load 190. When operating as a boost converter, the transient response also is inversely proportional to the inductance of inductor L1. For example, f_{RHP-zero}≈R/2π*L(VIN/VOUT)², where f_{RHP-zero} is the frequency of the right-hand pole zero in the real-imaginary plane. Accordingly, to achieve a small output voltage ripple when operating as buck converter, a larger value of the inductance of inductor L1 is used but a large inductance value results in smaller transient response. Advantageously, the use of voltage support circuit 120 allows a larger value of the inductance of inductor L1 to be used to achieve a smaller output voltage ripple when operating bidirectional power converter 410 as a buck converter while reducing the magnitude of the decrease in output voltage during a load transient when operating bidirectional power converter 410 as a boost converter.

In the example of FIG. 4, buffer 206 has an enable input 206c. Enable signal EN from control circuit 425 is also provided to enable input 206c of buffer 206. When the logic state of the enable signal EN is at a level to configure bidirectional power converter 410 to operate as boost converter (e.g., EN is logic high), enable signal EN causes buffer 206 to be enabled to allow voltage support circuit 120 to reduce the magnitude of the drop of voltage V2 during a load transient. When the logic state of the enable signal EN is at a level to configure bidirectional power converter 410 to operate as buck converter, enable signal EN causes buffer 206 to be disabled to thereby prevent voltage support circuit 120 from influencing the level of voltage V2.

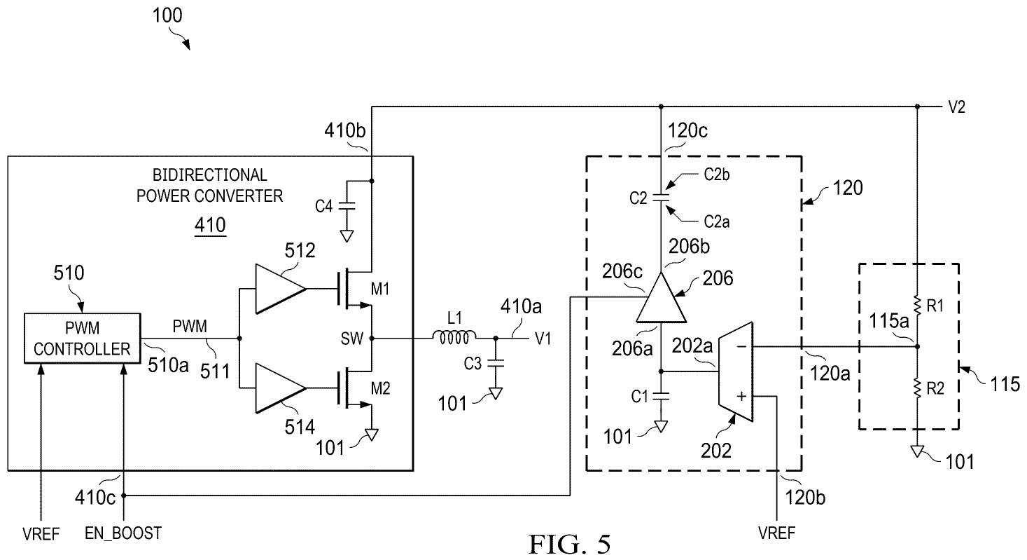

FIG. 5 is a schematic diagram of schematic diagram of the power device 100 of FIG. 4 showing an example implementation of bidirectional power converter 410. In the example of FIG. 5, bidirectional power converter 410 includes a pulse width modulation (PWM) controller 510, drivers 512 and 514, transistors M1 and M2, and a capacitor C4. Transistors M1 and M2 are n-channel field effect transistors (NFETs) but can be implemented as different types of transistors in other examples. The output 510a of PWM controller 510 is coupled to the inputs of drivers 512 and 514. Drivers 512 and 514 are gate drivers. The output of driver 512 is coupled to the gate of transistor M1, and the output of driver 514 is coupled to the gate of transistor M2. The source of transistor M1 is coupled to the drain of transistor M2 at a switching terminal SW. One terminal of inductor L1 is coupled to the switching terminal SW, and the other terminal of inductor L1 is coupled to capacitor C3 and carries voltage V1. One terminal of capacitor C4 is coupled to terminal 410a of bidirectional power converter 410 and to the drain of transistor M1 and carries voltage V2, and the other terminal of capacitor C4 is coupled to the voltage supply terminal 101. The source of transistor M2 is coupled to the voltage supply terminal 101.

PWM controller 510 generates a PWM signal 511 which is provided to drivers 512 and 514. Driver 512 turns on and off transistor M1 based on the PWM signal 511. Similarly, driver 514 turns on and off transistor M2 based on the PWM signal 511. For example, when the PWM signal 511 is at a logic high state, driver 512 turns on transistor M1 and driver 514 turns off transistor M2. When the PWM signal 511 is at a logic low state, driver 512 turns off transistor M1 and driver 514 turns on transistor M2. Based on the logic state of the enable boost signal EN_BOOST, PWM controller 510 controls the on and off states of transistors M1 and M2 in accordance with a duty cycle of PWM signal 511 to thereby operate the bidirectional power converter 410 as either a boost converter or a buck converter.

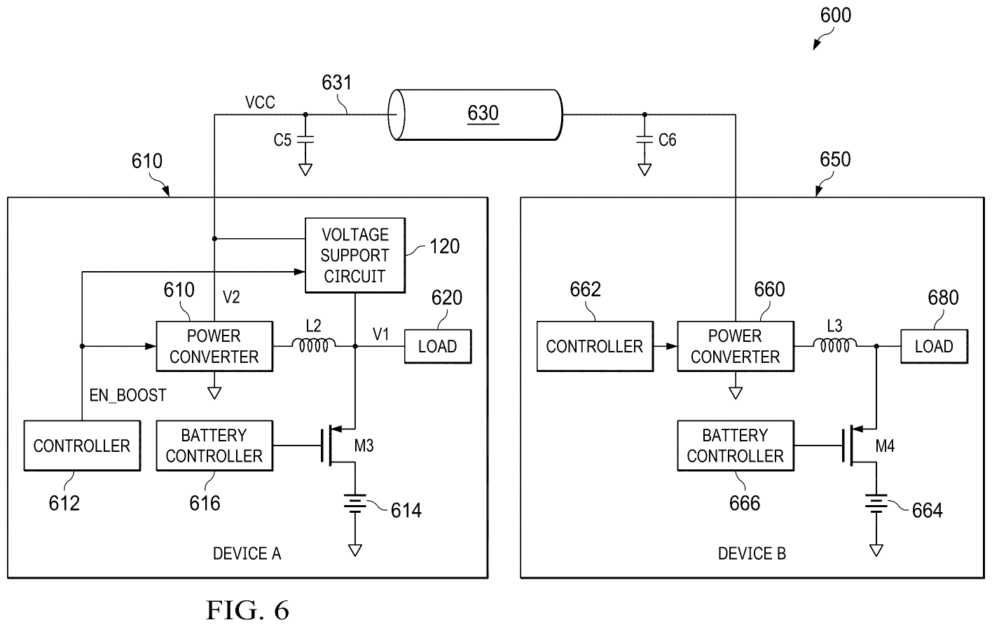

FIG. 6 is a system diagram 600 illustrating a device A 610 coupled to a device B 650 by way of an electrical cable 630 containing one or more conductors 631. In one example, device A 610 and device B 650 are coupled together by way of a Universal Serial Bus (USB) connection. Conductor 631 may carry a supply voltage (VCC) voltage between devices A and B. Device A 610 includes a power converter 610, a controller 612, the voltage support circuit 120, a battery 614, a battery controller 616, a transistor M3, an inductor L3, and a load 620. Load 620 may include, for example, a processor, memory, and/or other components of device A. Similarly, device B 650 includes a power converter 660, a controller 662, a battery 664, a battery controller 666, a transistor M4, an inductor L4, and a load 680. Load 680 may include, for example, a processor, memory, and/or other components of device B. In one example, device A 610 is a device whose battery 614 is a single-cell battery such as a mobile phone, and device B 650 is a device whose battery 664 is a multi-cell battery such as a portable computer. In other examples, both devices A and B are mobile phones or both are portable computers.

Power converter 610 may be a bidirectional power converter (both buck and boost, as described above), and power converter 660 may be a buck converter. Controllers 612 and 662 are coupled to their respective power converters 610 and 660. Controller 612 may assert the enable boost signal EN_BOOST to configure power converter 610 to be either a buck converter or a boost converter. In an example scenario, controller 612 configures power converter 610 to operate as a boost converter and enables voltage support circuit 120. Battery controller 616 asserts a control signal to the gate of transistor M3 to turn on transistor M3 thereby providing the voltage from battery 614 to power converter 610 through inductor L2. As a boost converter, power converter 610 provides an output voltage (V2) which is at a higher level than the battery's voltage. The voltage V2 from power converter 610 is provided over cable 630 as voltage VCC to power converter 660 in device B 650. Power converter 660 may be a buck converter to provide a supply voltage to load 680 and/or charge battery 664. Battery controller 666 can electrically couple or decouple battery 664 from load 680. Voltage support circuit 120 helps to reduce the drop in voltage V2 due to a load transience of device B 650.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described examples, and other examples are possible, within the scope of the claims.

What is claimed is:

1. An apparatus, comprising:
a power converter having a first voltage terminal and a second voltage terminal;
a voltage divider coupled between the second voltage terminal and a voltage supply terminal, the voltage divider having an output;
a transconductance amplifier having a first input, a second input, and an output, the first input coupled to the output of the voltage divider, the second input coupled to a reference voltage circuit;
a first capacitor coupled between the output of the transconductance amplifier and the voltage supply terminal;
a buffer having an input coupled to the output of the transconductance amplifier and having an output; and
a second capacitor coupled between the output of the buffer and the second voltage terminal.

2. The apparatus of claim 1, wherein the power converter is bidirectional.

3. The apparatus of claim 2, wherein the power converter has an enable input and is configured to operate as a boost converter when a signal at the enable input is in a first logic state and is configured to operate as a buck converter when the signal is in a second logic state.

4. The apparatus of claim 3, wherein, when configured to operate as a boost converter, the power converter is configured to convert a first voltage received at the first voltage terminal to a second voltage at the second voltage terminal.

5. The apparatus of claim 3, wherein the enable input is a first enable input, the buffer has a second enable input, and wherein:
when the second enable input of the buffer is at the first logic state, the buffer is configured to be enabled; and
when the second enable input of the buffer is at the second logic state, the buffer is configured to be disabled.

6. An apparatus, comprising:
a power converter having a first voltage terminal and a second voltage terminal; and
an amplifier having a first input, a second input, and an output, the first input and the output coupled to the second voltage terminal.

7. The apparatus of claim 6, wherein the amplifier is a transconductance amplifier.

8. The apparatus of claim 6, further comprising a capacitor coupled between the output of the amplifier and the second voltage terminal.

9. The apparatus of claim 6, wherein the power converter is bidirectional.

10. The apparatus of claim 6, further comprising a buffer coupled between the output of the amplifier and the second voltage terminal.

11. The apparatus of claim 10, wherein:
the power converter has a first enable input and is configured to operate as a boost converter when the first enable input is at a first logic state and to operate as a buck converter when the first enable input is at a second logic state; and
the buffer has a second enable input coupled to the first enable input, the buffer configured to be enabled when the second enable input is at the first logic state and to be disabled when the second enable input is at the second logic state.

12. The apparatus of claim 10, wherein the amplifier is a transconductance amplifier, and the apparatus further comprises a capacitor coupled between the output of the transconductance amplifier and a voltage supply terminal.

13. The apparatus of claim 12, wherein the capacitor is a first capacitor, the buffer has a buffer output, and the apparatus further comprises a second capacitor coupled between the buffer output and the second voltage terminal.

14. An apparatus, comprising:
a power converter having a first voltage terminal and a second voltage terminal; and
a voltage support circuit having an input and an output, the input and the output coupled to the second voltage terminal, the voltage support circuit configured to respond to a reduction in an output voltage at the second voltage terminal by increasing the output voltage based on a reference voltage and the output voltage.

15. The apparatus of claim 14, wherein the voltage support circuit includes an amplifier having an input coupled to the input of the voltage support circuit and having an output.

16. The apparatus of claim 15, further comprising a capacitor coupled between the output of the amplifier and the second voltage terminal.

17. The apparatus of claim 16, further comprising a buffer coupled between the output of the amplifier and the capacitor.

18. The apparatus of claim 17, wherein the capacitor is a first capacitor, and the amplifier is a transconductance amplifier having the output of the amplifier, and the apparatus further comprises a second capacitor coupled between the output of the transconductance amplifier and a voltage supply terminal.

19. The apparatus of claim 14, wherein the power converter is a boost converter.

20. The apparatus of claim 17, wherein:
the power converter has a first enable input and is configured to operate as a boost converter when the first enable input is at a first logic state and to operate as a buck converter when the first enable input is at a second logic state; and
the buffer has a second enable input coupled to the first enable input, the buffer configured to be enabled when the second enable input is at the first logic state and to be disabled when the second enable input is at the second logic state.
